(19) United States
(12) Patent Application Publication
(10) Pub. No.: US 2008/0145097 A1
(43) Pub. Date: Jun. 19, 2008

(54) Activation Mechanism for a Shutter

(76) Inventors: Samuel Tsui, Hong Kong (CN); Guan Long Dong, Shen Zhen City (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,974

(22) PCT Filed: Jan. 25, 2006
(86) PCT No.: PCT/AU2006/000077

§ 371 Date: Jul. 25, 2007

(30) Foreign Application Priority Data
Jan. 25, 2005 (AU) 2005900298

(51) Int. Cl. G03G 21/18

(52) U.S. Cl. 399/114

(57) ABSTRACT

An activation mechanism for a shutter (12) of a process cartridge has a spacer arm (18) with a contact projection (34); a lever arm (20) with a contact tab (38); biasing means (26) for biasing the shutter (12) in a closed position; and biasing means (46 for biasing the lever arm (209 toward the contact projection (34). When force is applied to a first side (56) of the contact tab (38), the lever arm (20) moves in a first direction (A), engaging the contact projection (34) of the spacer arm (18) and thus moving the shutter (12) to an open position. If a force is applied to the opposite side (58) of the contact tab (38) (eg, during incorrect insertion of the process cartridge), the lever arm (20) rotates in a second direction (B), and may move into a recess (32) of the spacer arm (18).

### FIELD OF THE INVENTION

The invention relates to an activation mechanism for a shutter. In particular, the invention relates to an activation mechanism for a shutter adapted for covering a photosensitive drum of a process cartridge or drum cartridge.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

The typical process cartridge has a transfer opening. The transfer opening is an opening in the cartridge that allows an organic photosensitive cylinder (“OPC”) to be exposed to a mating part in an image forming apparatus. However, due to the fragility of the OPC, it is common for process cartridges to include a shutter to protect the OPC from undue exposure when not inserted Into the image forming apparatus. To attend to this change in state of the shutter, the shutter has an activation mechanism

Commonly, the activation mechanism is an integrally formed tab that contacts a predetermined portion of the image forming apparatus upon insertion of the cartridge. The problem here is that the tab is often able to engage with portions of the image forming apparatus other than the predetermined portion during insertion and removal of the cartridge. These engagements may result in damage or breakage of the tab and thus render the cartridge inoperable. An example of this type of cartridge 1 is shown in FIGS. 1a and 1b.

As shown in FIGS. 1a and 1b, the cartridge 1 comprises a shutter 2, a tab 3 and a spring 4. The tab 3 is adapted to engage the predetermined portion of the Image forming apparatus (not shown) and thereby change the state of the shutter 2 from a closed to an open position. The spring 4 is biased to the closed position, thus allowing the shutter 2 to change its state back to the closed position when the tab 3 does not engage the predetermined portion of the image forming apparatus.

A further problem with this design is that if the cartridge is inserted into, an image forming apparatus for which the cartridge is not compatible, it is possible for the tab to damage the image forming apparatus.

It is an object of the present invention to provide an activation mechanism for a shutter that overcomes, or at least ameliorates in part, one or more of the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is an activation mechanism for a shutter comprising:
a spacer arm connected to the shutter, the spacer arm having a contact extending from one side thereof;
a lever arm having a contact tab, at least a portion of the lever arm in close proximity to the contact;
a first resilient means for biasing the spacer arm towards a first position; and
a second resilient means for biasing the lever arm towards a third position,
   where, when force is applied to a first side of the contact tab, the lever arm rotates in a first direction such that the lever arm engages the contact, pulling the lever arm in the first direction, and thereby moving the shutter to a second position, and where, when force is applied to a second side of the contact tab, opposite the first side, the lever arm rotates in a second direction, opposite the first direction, until it reaches a fourth position.

Preferably:
the first position is a position where the shutter covers an opening;
the second position is a position where the shutter uncovers the opening;
the third position is a position where the lever arm abuts the contact; and
the spacer arm has an elongated recess provided therein and the fourth position is a position where at least a portion of the lever arm is received within the elongated recess.

The lever arm may be pivotally connected to the spacer arm. This connection may be facilitated by a second resilient means in the form of a coil spring. The first resilient means may also be a coil spring.

The contact may be an arch. Further, the lever arm may include means for facilitating engagement with the contact and rotation of the contact in the first direction. This may take the form of a lip.

In accordance with a second aspect of the invention there is a cartridge including an activation mechanism for a shutter comprising:
a spacer arm connected to the shutter, the spacer arm having a contact extending from one side thereof;
a lever arm having a contact tab, at least a portion of the lever arm in close proximity to the contact;
a first resilient means for biasing the spacer arm towards a first position; and
a second resilient means for biasing the lever arm towards a third position,
   where, when force is applied to a first side of the contact tab, the lever arm rotates in a first direction such that the lever arm engages the contact, pulling the lever arm in the first direction, and thereby moving the shutter to a second position, and where, when force is applied to a second side of the contact tab, opposite the first side, the lever arm rotates in a second direction, opposite the first direction, until it reaches a fourth position.

Ideally, the shutter covers a transfer opening of the cartridge and the second position is a position where the shutter uncovers the transfer opening,

### BRIEF DESCRIPTION OF THE DRAWINGS

The invention will now be described, by way of example only, with reference to the accompanying drawings, in which;

FIG. 1a is an isometric view of a common prior art process cartridge having a shutter in a closed position.

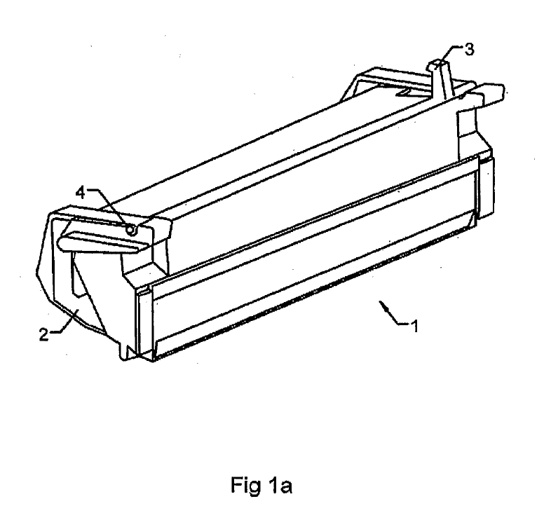

FIG. 1b is an isometric view of the common prior art process cartridge shown in FIG. 1a having the shutter in an open position.

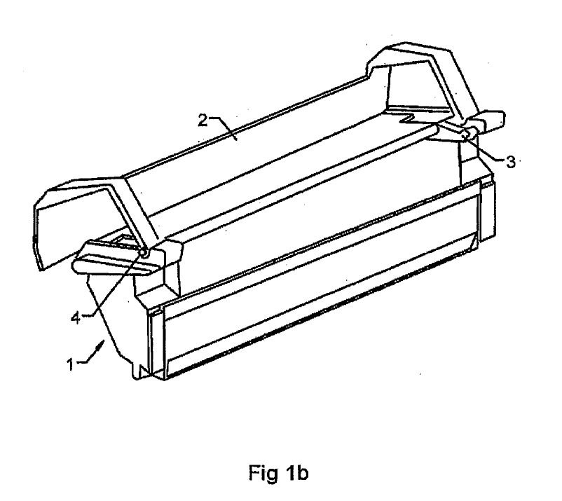

FIG. 2 is a first exploded isometric view of an activation mechanism for a shutter according to the present invention.

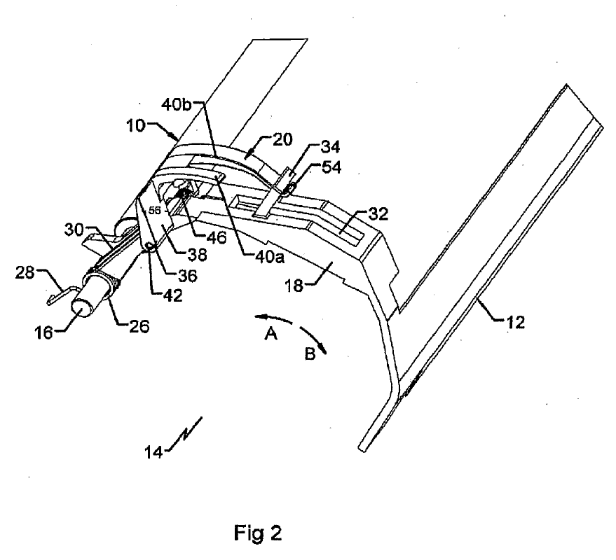

FIG. 3 is a second exploded isometric view of the activation mechanism shown in FIG. 2.

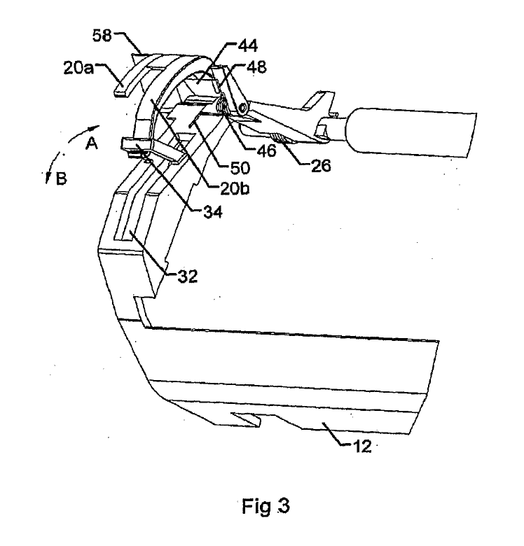

FIG. 4 is a front isometric view of the activation mechanism shown in FIG. 2.

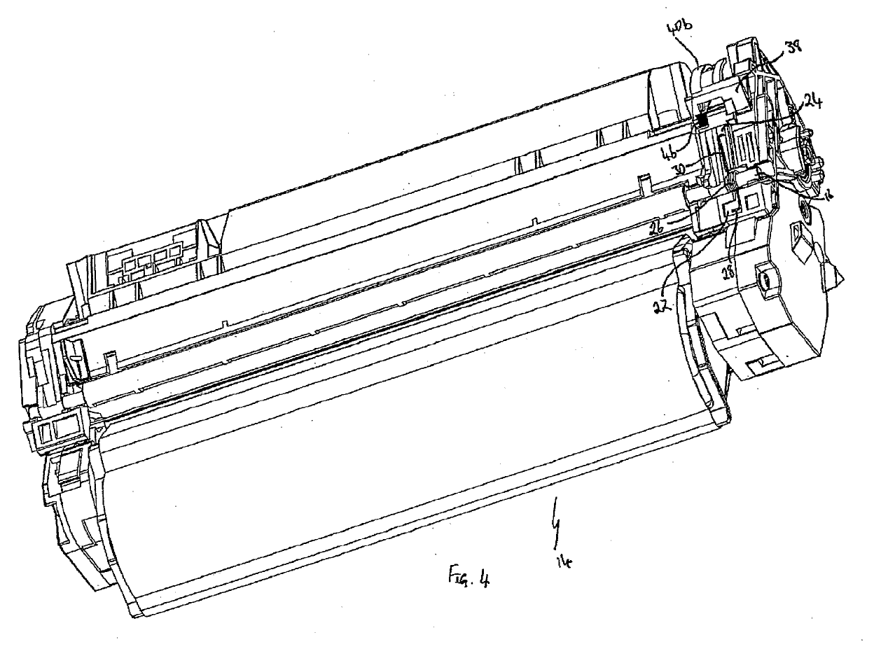

FIG. 5 is a cross-sectional view of a process cartridge including the activation mechanism shown in FIG. 2 in a closed position,

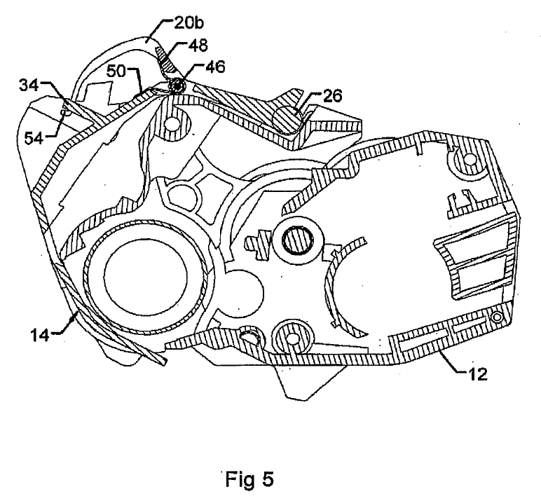

FIG. 6 is a cross-sectional view of a process cartridge including the activation mechanism shown in FIG. 2 in an open position.

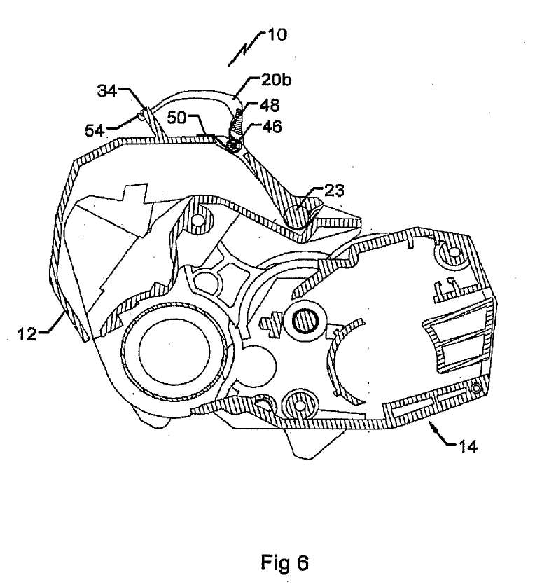

### PREFERRED EMBODIMENTS OF THE INVENTION

In accordance with the preferred embodiment of the invention there is an activation mechanism 10 for a shutter 12 of a process cartridge 14.

The shutter 12 is mounted to the process cartridge 14 by way of a shaft 16. However, the shutter 12 is spaced from the shaft 16 by way of the activation mechanism 10 and a connecting arm 17.

The activation mechanism 10 comprises a spacer arm 18 and a lever arm 20. The spacer arm 18 is integrally connected to both the shutter 12 and the shaft 16. The shape formed by the spacer arm 18 and the shutter 12, in cross-section, is substantially similar to a ‘]’.

The spacer arm 18 has a recessed channel 22 adjacent its connection to the shaft 16. A recessed portion 24 is provided for in the process cartridge 14, Recessed portion 24 is substantially opposite recessed channel 22 when the shaft 16 is taken as the reference point.

A first coil spring 26 is wound around the shaft 16 at a position approximately centred between the recessed channel 22 and the recessed portion 24. A first retaining arm 28 extends from the first coil spring 26 and is received within recessed channel 22. A second retaining arm 30 extends from the first coil spring 26 and is received within recessed portion 24.

The spacer arm 18 also has a through channel 32 adjacent its connection to the shutter 12. Positioned above the through channel 32 is an arch 34. The arch 34 is square in shape. The arch 34 is integrally formed with the spacer arm 18.

Bored through the spacer arm 18 at a position approximately equally spaced between the through channel 32 and the recessed channel 22 is a retaining hole 36.

The lever arm 20 comprises a contact tab 38 and a plurality of fingers 40. The contact tab 38 is wider than the spacer arm 18. The contact tab 38 is affixed to the spacer arm 18 by way of a pin 42 received within the retaining hole 36.

The contact tab 38 also has a cut-away portion 44 about the position of the connection to the spacer arm 18. The cut-away portion 18 is also wider than the spacer arm 18, the additional space being taken up by a second coil spring 46 would about the casing of the pin 42.

A first contact arm 48 extends from the second coil spring 46 and makes contact with the underside of the contact tab 38. A second contact arm 60 extends from the second coil spring 46 and makes contact with the spacer arm 18.

The plurality of fingers 40 are attached to the contact tab 38 by way or a base 52. The base 52 is attached to the contact tab 38 substantially at a right angle thereto.

The first finger 40a extends away from the base 52 from one end thereof. The second finger 40b extends away from the base 52 at the other end thereof. The second finger 40b is curved and has a lip 54 at its free end. The curve of the second finger 40b is such that the lip 54 abuts arch 34.

The invention will now be described in the context of its intended use.

As the process cartridge 14 is inserted into the image forming apparatus (not shown) with which it is designed to be used, the process cartridge 14 comes Into proximity with an exposure finger (not shown). The exposure finger is guided towards the contact tab 38 by way of first finger 40a. In this manner, proper contact between the exposure finger and the contact tab 38 is facilitated.

Upon the exposure finger making proper contact with the contact tab 38, the exposure finger applies force against a first side 56 of the contact tab 38 in direction A. As this applied force moves the contact tab 38, the lip 54 engages the arch 34. Further force thereafter causes the lip 54 to pull the arch 34 in direction A. The end result is that the activation mechanism 10 and connecting arm 17 rotate about the shaft 16.

To ensure that the OPC drum is covered when not in use, as the process cartridge 12 is removed from the image forming apparatus, the lack of contact between the exposure finger and the contact tab 38 allows the shutter 12 to return to its original position. This is facilitated by way of first coil spring 26, which is biased towards this original position. Thus, as the force applied by the exposure finger reduces, pressure is applied to the spacer arm 18 by way of first retaining arm 28 until such time as the spacer arm 18 cannot move any further in direction B.

However, If the same process cartridge 12 is inserted into an image forming apparatus for which it has not been designed, or incorrectly inserted into the image forming apparatus for which it has been designed, the activation mechanism 10 is protected from breakage. This is achieved due to the fact that contact made with a second side 58 of the contact tab 38 force the contact tab 38 to move in direction B. This forces finger 40a to retract until it abuts a ledge of the process cartridge 12. It also causes finger 40b to retract into through channel 32.

Second coil spring 46 is biased towards the original position. Accordingly, to allow correct operation of the process cartridge 12 following incorrect insertion, the contact arms 48, 50 return the contact tab 38, and thus fingers 40, to their original position.

It should be appreciated by the person skilled in the art that the above invention is not limited to the embodiment described. In particular, the following modifications and improvements may be made without departing from the scope of the present invention:
The coil springs 26, 46 may be replaced by other resilient means capable of performing the same function as these components as described above,
The lever ann 20 and the spacer arm 18 may both be connected to the shaft 6.
The arch 34 may be replaced with other forms of contact. For example, a simple bar extending in a direction parallel to the axial length of the photosensitive drum could be used to facilitate contact.
The lip 54 may be omitted. Alternatively, other methods for facilitating appropriate contact between the second finger 40b and arch 34 may be employed. For instance a hook may be used to engage the arch 34, or such other contact as may be employed on rotation of the second finger 40b in direction A.

It should be further appreciated by the person skilled in the art that the features described in one embodiment, where not mutually exclusive or alternatives, may be combined with features described in other embodiments described to create yet further embodiments that fall within the scope of the present invention.

1. An activation mechanism for a shutter comprising:
a spacer arm connected to the shutter, the spacer arm having a contact extending from one side thereof;
a lever arm having a contact tab, at least a portion of the lever arm in close proximity to the contact;
a first resilient means for biasing the spacer arm towards a first position; and
a second resilient means for biasing the lever arm towards a third position, where, when force is applied to a first side of the contact tab, the lever arm rotates in a first direction such that the lever arm engages the contact, pulling the lever arm in the first direction, and thereby moving the shutter to a second position, and where, when force is applied to a second side of the contact tab, opposite the first side, the lever arm rotates in a second direction, opposite the first direction, until it reaches a fourth position.

2. An activation mechanism for a shutter according to claim 1, where the first position is a position where the shutter covers an opening.

3. An activation mechanism for a shutter according to claim 2, where the second position is a position where the shutter uncovers the opening

4. An activation mechanism for a shutter according to claim 1, where the third position is a position where the lever arm abuts the contact.

5. An activation mechanism for a shutter according to claim 1, where the spacer arm has an elongated recess provided therein and the fourth position is a position where at least a portion of the lever arm is received within the elongated recess.

6. An activation mechanism for a shutter according to claim 1, where the lever arm is pivotally connected to the spacer arm.

7. An activation mechanism for a shutter according to claim 1, where the first resilient means is a coil spring.

8. An activation mechanism for a shutter according to claim 1, where the second resilient means is a coil spring.

9. An activation mechanism for a shutter according to claim 1, where the contact is an arch.

10. An activation mechanism for a shutter according to claim 1, where the lever arm has means for facilitating engagement with the contact and rotation of the contact in the first direction.

11. An activation mechanism for a shutter according to claim 10, where the means for facilitating engagement with the contact is a lip.

12. A cartridge including an activation mechanism for a shutter comprising:
a spacer arm connected to the shutter, the spacer arm having a contact extending from one side thereof;
a lever arm having a contact tab, at least a portion of the lever arm in close proximity to the contact;
a first resilient means for biasing the spacer arm towards a first position;
and a second resilient means for biasing the lever arm towards a third position, where, when force is applied to a first side of the contact tab, the lever arm rotates in a first direction such that the lever, arm engages the contact, pulling the lever arm in the first direction, and thereby moving the shutter to a second position, and where, when force is applied to a second side of the contact tab, opposite the first side, the lever arm rotates in a second direction, opposite the first direction, until it reaches a fourth position,

13. A cartridge according to claim 12, where the first position is a position where the shutter covers a transfer opening of the cartridge.

14. A cartridge according to claim 13, where the second position is a position where the shutter uncovers the transfer opening.

15-16. (canceled)
